(19) United States
(12) Patent Application Publication
(10) Pub. No.: US 2007/0225968 A1
(43) Pub. Date: Sep. 27, 2007

(54) Extraction of Compounds

(75) Inventors: Akiko Murakami, Kawasaki-shi (JP); Hideo Watanabe, Tokyo (JP)

Correspondence Address: SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/681,170

(22) Filed: Mar. 26, 2007

(30) Foreign Application Priority Data
Mar. 24, 2006 (JP) 2006-82026

(51) Int. Cl. G06F 17/27

(52) U.S. Cl. 704/9

(57) ABSTRACT

A system for extracting a compound from a plurality of texts is provided. The system includes an obtaining section that analyzes a plurality of first texts and obtains a compound candidate based on analysis of the plurality of first texts, a calculation section that searches a plurality of second texts for each word included in the compound candidate and calculates appearing frequencies of each word included in the compound candidate in the plurality of second texts, and a selection section that selects whether to extract the compound candidate as a compound on the basis of whether or not changes in the appearing frequencies of each word included in the compound candidate synchronize with one another when the appearing frequencies of each word included in the compound candidate are arranged as time series data.

### CROSS-REFERENCE TO RELATED APPLICATIONS

This application claims benefit under 35 U.S.C. §119 of Japanese Patent Application No. 2006-082026, filed on Mar. 24, 2006, which is hereby incorporated by reference in its entirety for all purposes as if fully set forth herein.

### FIELD OF THE INVENTION

The present invention relates to a system for extracting a phrase from a plurality of texts. Specifically, the present invention relates to a system for extracting a phrase on the basis of frequency in which the phrase appears.

### BACKGROUND OF THE INVENTION

Consumers can post their comments, complaints, and the like about companies and their goods and services to bulletin boards and weblogs on the Internet. Such information is larger in volume and is easily collected, compared with conventional cases where such information is, for instance, collected in call centers or collected as answers to questionnaires. Furthermore, consumers tend to post frank opinions on bulletin boards and weblogs. Companies could further promote the planning of business strategies if such information is utilized.

Consumers can post texts in any style to bulletin boards and weblogs. Techniques for extracting useful information from such texts in various styles are called “text mining” or the like, and have been studied (refer to: J. Kleinberg, 2002 Bursty and Hierarchical Structure in Streams, KDD 2002, pgs. 91-101; Sato Yoshihide, Kawashima Harumi, Sasaki Tsutomu, and Oku Masahiro, 2005 ZIKEIRETSU NYUSU NI OKERU SAISHIN-WADAIGO-CHUUSHUTSU-HOUHOU (Method for Extracting Terms of Current Information of Temporal News), Information Processing Society of Japan, Special Interest Group of Natural Language Processing, NL168, pgs. 1-12; Sekiguchi Yuuichiro, Sato Yoshihide, Kawashima Harumi, Okuda Hidenori, and Oku Masahiro, 2005 BLOG-PEZI-SYUUGOU NI TAISURU WADAIGOKU CHUUSHUTSU SYUHOU (Method for Extracting Terms of Current Topics in Blog Page Assembly), Information Processing Society of Japan, Special Interest Group of Natural Language Processing, NL170, pgs. 27-32; Japanese Patent Application Laid-Open Official Gazette No. 2001-325272; Japanese Patent Application Laid-Open Official Gazette No. 2004-206391; Japanese Patent Application Laid-Open Official Gazette No. 2002-251402; and Japanese Patent Application Laid-Open Official Gazette No. 2005-165748). In text mining, a frequency in which a keyword appears in texts and a change in the frequency over time are generally analyzed. The keyword in this context may be a single word or may be a compound consisting of a combination of words. However, it is not easy to appropriately determine a keyword to focused on, and the determination may cause a large difference in the text mining results.

Conventionally, techniques for detecting an appropriate segment of a phrase as a compound (refer to: S. Ananiadou, 1994 A Methodology For Automatic Term Recognition, COLING 1994: 1034-1038; Nakagawa H. and Mori T., 2003 Automatic Term Recognition based on Statistics of Compound Nouns and their Components, Terminology, Vol. 9, No. 2, pgs. 201-219; Nakagawa Hiroshi, Mori Tatsunori, and Yumoto Hiroaki, 2003 SYUTUGEN-HIND TO RENSETU-HINDO NI MOTODUKU SENMON-YOUGO CHUUSHUTSU SIZEN-GENGO-SYORI (Terminology Extraction and Natural Language Processing based on Appearing Frequency and Linking Frequency), Vol. 10, No. 1, pgs. 27-45; and Japanese Patent Application Laid-Open Official Gazette No. 2002-245062) from words appearing successively in texts have been studied. In each of the techniques, a compound is extracted by using frequencies at which the respective words appear in texts (also referred to as “appearing frequency” below). For instance, in a case where various words appear in adjacent places to a certain compound candidate, it is not appropriate to determine a compound by including these adjacent words. In this case, it is necessary to determine only the compound candidate as a compound. However, when the appearing frequency of the compound is low as a whole in a corpus and the compound is used only temporarily in vogue, these techniques fail to judge a compound appropriately.

In addition, the following methods have been also studied. In one method, a user constructs a dictionary in which compounds are recorded. In another method, a noun phrase obtained as a result of grammatical analysis is regarded as a compound. However, it is not realistic to register all compounds in a dictionary, since labor and time are required to construct the dictionary and compounds are sometimes spontaneously created. Moreover, a noun phrase, which is obtained as a result of grammatical analysis, may be inappropriate as a keyword for text mining, since the noun phrase may appear in a corpus significantly less frequently.

### SUMMARY OF THE INVENTION

An object of the present invention is to provide a system, a method, and a program with which the above-described problems can be solved. The object is achieved by a combination of characteristics of independent claims in the scope of claims. In addition, the dependent claims define further examples of the invention.

In order to solve the above-described problems, an aspect of the present invention is to provide a system for extracting a compound from a plurality of texts, a program that causes an information processing device to function as the system, and a method of extracting a compound from a plurality of texts. The system includes an obtaining section, a calculation section and a selection section. The obtaining section analyzes a plurality of first texts and obtains a compound candidate based on analysis of the plurality of first texts. The calculation section searches a plurality of second texts for each word included in the compound candidate and calculates appearing frequencies of each word included in the compound candidate in the plurality of second texts. The selection section selects whether to extract the compound candidate as a compound on the basis of whether or not changes in the appearing frequencies of each word included in the compound candidate synchronize with one another when the appearing frequencies of each word are arranged as time series data in which the appearing frequencies of each word included in the compound candidate are in chronological order based on publication dates of the plurality of second texts.

Note that the general descriptions of the present invention provided above do not cover all of the necessary characteristics of the invention, and that sub-combinations of groups of those characteristics can be the invention as well.

The present invention makes it possible to accurately detect a segment of a plurality of words that successively appear in a text as a compound.

### BRIEF DESCRIPTION OF THE DRAWINGS

For a more complete understanding of the present invention and the advantage thereof, reference is now made to the following description taken in conjunction with the accompanying drawings.

FIG. 1 shows an information processing system according to an embodiment of the present invention.

FIG. 2 is a flowchart of processing steps performed by a compound extraction device to extract a compound according to an embodiment of the present invention.

FIG. 3 shows sample appearing frequencies of the word “bird” as time series data.

FIG. 4 shows sample appearing frequencies of the word “flu” as time series data.

FIG. 5 shows sample appearing frequencies of the word “problem” as time series data.

FIG. 6 shows sample appearing frequencies of the phrase “train explosion accident” as time series data

FIG. 7 shows sample appearing frequencies of the word “train” as time series data.

FIG. 8 shows sample appearing frequencies of the word “explosion” as time series data.

FIG. 9 shows sample appearing frequencies of the word “accident” as time series data.

FIG. 10 is a flowchart of processing steps performed by a text retrieval device to retrieve texts according to an embodiment of the present invention.

FIG. 11 shows a sample display for retrieval results outputted by a search section according to an embodiment of the present invention.

FIG. 12 shows an information processing device according to an embodiment of the present invention.

### DETAILED DESCRIPTION

Descriptions will be provided below for the invention with a best mode for carrying out the invention. However, the following embodiments do not limit the invention or the scope of the claims. In addition, all combinations of the characteristics described in the embodiments are not necessarily required as solving means of the invention.

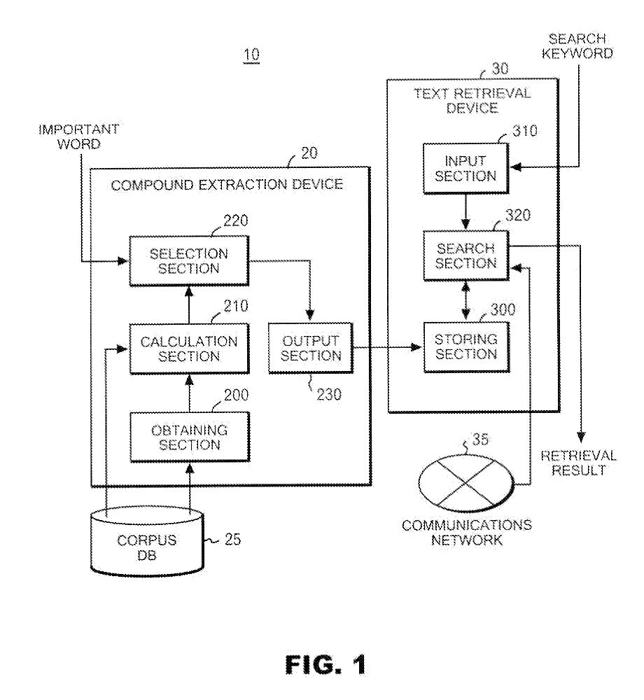

FIG. 1 shows an information processing system 10 according to an embodiment of the present invention. The information processing system 10 includes a compound extraction device 20 and a text retrieval device 30. The compound extraction device 20 extracts a compound from a plurality of texts recorded in a corpus database (DB) 25. In the corpus DB 25, the plurality of texts, which are collectively called “a corpus,” are recorded. The corpus includes a plurality of first texts and a plurality of second texts. The first texts are used to obtain compound candidates and the second texts are used to calculate frequencies at which a compound candidate or each word included in the compound candidate appears (also referred to as “appearing frequencies” below). The corpus may be configured by collecting texts, for instance, from electronic bulletin boards or weblogs in the Internet. The text retrieval device 30 searches a plurality of third texts, via a communication network 35, using one or more search keywords inputted by a user, and outputs a result of the search. Additionally, when a combination of the one or more search keywords inputted by the user constitutes a compound, the text retrieval device 30 may further search the third texts using the compound.

As described, an object of the information processing system 10 is to accurately detect an appropriate segment of a phrase as a compound on the basis of texts in a corpus. Another object is to enhance efficiency of text searching using a detected compound. Various embodiments will be described in detail below.

The compound extraction device 20 includes an obtaining section 200, a calculation section 210, a selection section 220, and an output section 230. The obtaining section 200 analyzes the first texts, and obtains a plurality of compound candidates. Two or more words may constitute a compound candidate when the two or more words appear successively in the first texts. For instance, when the phrase “bird flu problem” appears in the first texts, “bird flu,” “bird flu problem,” and “flu problem” can all be compound candidates. As an example, the obtaining section 200 may analyze the syntax of each of the first texts to determine the word class of each word in the respective first text, and then obtain a plurality of successively appearing nouns as a compound candidate. In addition, the obtaining section 200 may only decide to treat a phrase as a compound candidate if a frequency at which the phrase appears in the corpus DB 25 (also referred to as “appearing frequency”) is greater than a predetermined frequency.

For each of the plurality of compound candidates, the calculation section 210 searches the second texts for each word included the corresponding compound candidate and calculates frequencies at which each word included in the corresponding compound candidate appears in the second texts. For instance, given five second texts and a compound candidate of “bird flu problem,” the calculation section 210 calculates an appearing frequency for each of the words “bird,” “flu,” and “problem” included in the compound candidate “bird flu problem” for each of the five second texts, resulting in a total of fifteen calculated appearing frequencies (i.e., five appearing frequencies for each of the three words in the compound candidate).

In addition, the calculation section 210 searches the second texts for each of the plurality of compound candidates and calculates frequencies at which each of the plurality of compound candidates appears in the second texts. For instance, given ten second texts and compound candidates of “bird flu problem” and “train explosion accident,” the calculation section 210 calculates an appearing frequency of the phrase “bird flu problem” in each of the ten second text and an appearing frequency of the phrase “train explosion accident” in each of the ten second texts, resulting in a total of twenty calculated appearing frequencies (i.e., ten appearing frequencies for each of the two compound candidates). The first texts, from which the obtaining section 200 obtains the compound candidates, and the second texts, with which the calculation section 210 calculates the appearing frequencies, may be identical, may be different, or may be partially identical.

The selection section 220 performs the following processing on each of the plurality of compound candidates. First, a case will be described in which one of the compound candidates includes a previously specified word, also referred to as an important word. In this case, the selection section 220 selects whether or not to extract the compound candidate as a compound on the basis of whether or not changes in the appearing frequencies of the important word synchronize with changes in the appearing frequencies of a different word included in the compound candidate when the appearing frequencies of the important word and the appearing frequencies of the different word are arranged in chronological order based on publication dates of the second texts. When the appearing frequencies of a word are arranged in the order in which the second texts are made public, time series data is created for the word. Hence, in the above processing, two time series data are involved, one for the important word and another one for the different word.

For example, assume that there are five second texts, the compound candidate is “bird flu problem,” the important word is “bird,” the different word is “flu,” the appearing frequencies of the word “bird” in the five second texts are 3, 2, 5, 6, and 10 when arranged in chronological publication order, and the appearing frequencies of the word “flu” in the five second texts are 5, 4, 7, 8, and 12 when arranged in chronological publication order. In the example, the changes in the appearing frequencies of the important word and the changes in the appearing frequencies of the different word synchronize with one another because the changes in the appearing frequencies of the important word is +1, −1, +3, +1, +4, and the changes in the appearing frequencies of the different word is also +1, −1, +3, +1, +4.

If the changes in the respective appearing frequencies of the important word and the different word synchronize with each other, the selection section 220 selects the compound candidate as a compound. If not, the selection section 220 does not select the compound candidate as a compound.

The important word may be, for instance, a word previously specified by a user as important in a field to which the content of a corpus belongs. From a viewpoint of linguistics, such an important word is desirably a word which is strongly related to a concept of a linguistic unit peculiar to the field. Note that various methods may be used to determine an important word. For instance, an important word may be a medium frequency word with appearing frequencies that vary within a range between a predetermined upper limit and a predetermined lower limit over a particular period of time. In addition, in order to regard a medium frequency word as an important word, it may be desirable that the medium frequency word have a specific relationship with the different word included in compound candidate, such as the different word is a modifier on the medium frequency word (e.g., the medium frequency word is modified by the different word).

Alternatively, an important word may be detected by use of a conventional technique for defining a word that is at the center of the topic of interest. The details of such techniques can be understood by referring to Nagano, T., Takeda, K., and Nasukawa, T. 2001, Knowledge Discovery using Robust Natural Language Processing, In Proc. of PACLING 2001. As to another example, selection section 220 may detect a word, which is peculiar to a field, by use of a technique such as TFIDF (term frequent and inversed document frequency), and judge the word as an important word.

In contrast to the above case, the selection section 220 performs the following processing on the condition that none of the words included in the compound candidate is a medium frequency word or a word previously specified as important in the field to which the corpus belongs. The selection section 220 selects whether to extract the compound candidate as a compound on the basis of whether or not changes in the appearing frequencies of the compound candidate synchronize with changes in the appearing frequencies of each word included in the compound candidate when the appearing frequencies of the compound candidate and the appearing frequencies of each word included in the compound candidate are arranged as time series data in which the appearing frequencies of the compound candidate and the appearing frequencies of each word included in the compound candidate are in chronological order based on publication dates of the plurality of second texts.

The selection section 220 extracts the compound candidate as a compound on the condition that the time series data for the compound candidate does not synchronize with the time series data for each word included the compound candidate. The output section 230 outputs the compound selected by the selection section 220 to the text retrieval device 30.

The text retrieval device 30 includes a storing section 300, an input section 310, and a search section 320. When a plurality of title words have been set in advance, the search section 320 searches a plurality of target third texts, obtains third texts that include the plurality of title words, and stores the obtained third texts in association with the each of the title words in the storing section 300. The plurality of target third texts in this context are, for instance, web pages, electronic bulletin boards, weblogs, and the like, which are accessible via the communication network 35 when the search is performed. The input section 310 receives an input of a search keyword. The search section 320 searches the plurality of target third texts via the communication network 35 and retrieves third texts that include the inputted search keyword. If the inputted search keyword is one of the title words that have been set in advance, the search section 320 reads the third texts that correspond to the one title word from the storing section 300 instead of retrieving third texts that include the inputted search keyword via the communication network 35. Thereafter, the search section 320 outputs the third texts that include the inputted search keyword as a detection result.

As described, the text retrieval device 30 retrieves third texts corresponding to the title words at an earlier point in time. This shortens a required time period between a time point when the text retrieval device 30 receives an input by a user, and a time point when the text retrieval device 30 outputs the detection result. For this reason, a title word is desirably one expected to be inputted as a search keyword. For this reason, by setting a selected compound as title words in the text retrieval device 30, the selection section 220 may cause the text retrieval device 30 to retrieve third texts that include the compound, and may cause the storing section 300 to store the retrieved third texts. This makes it possible to register, for instance, buzzwords, which are newly used, as title words, thereby shortening a time period required for search processing.

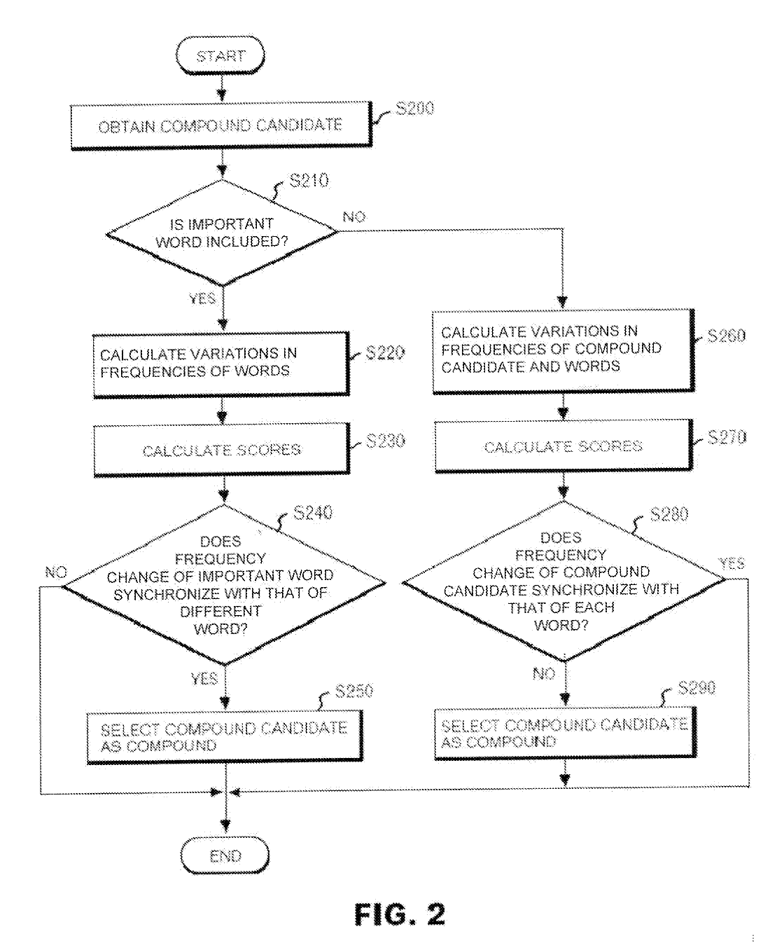

FIG. 2 is a flowchart of processing steps performed by the compound extraction device 20 to extract a compound according to an embodiment of the present invention. The obtaining section 200 obtains a plurality of compound candidates (Step S200). Thereafter, the compound extraction device 20 performs the following processing on each of the compound candidates. First, the compound extraction device 20 judges whether or not the compound candidate includes an important word (Step S210). For instance, assume that the word “flu” has been specified as important in a specific field.

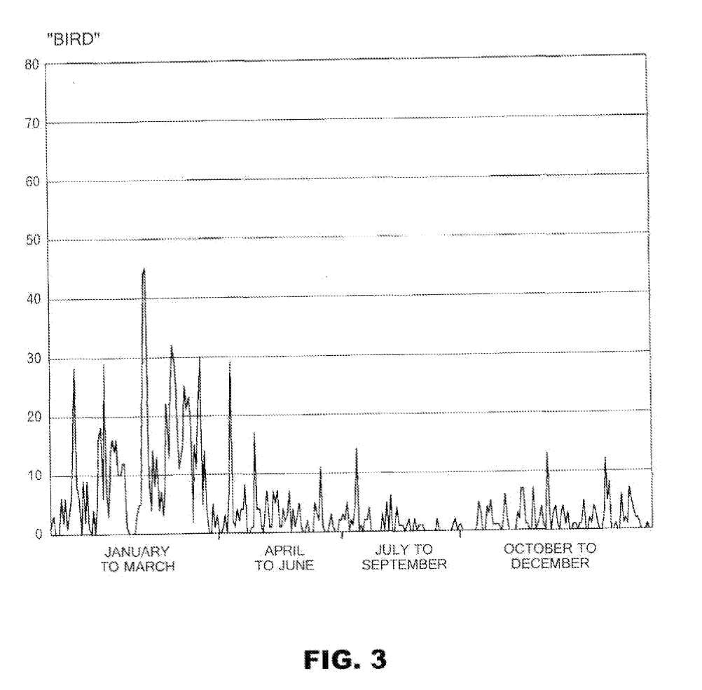

On the condition that the compound candidate includes the important word (step S210: YES), the calculation section 210 searches a plurality of second texts in order to find words included in the compound candidate, and calculates appearing frequencies of each of the words in the plurality of second texts. For instance, when one of the compound candidates is “bird flu problem,” the calculation section 210 calculates appearing frequencies for each of the words “bird,” “flu,” and “problem.” FIGS. 3 to 5 illustrate sample appearing frequencies of the words “bird,” “flu,” and “problem” in the plurality of second texts in corpus DB 25 as time series data (i.e., arranged in chronological order based on publication dates of the plurality of second texts).

FIG. 3 is time series data showing sample appearing frequencies of the word “bird,” which is included in the compound candidate “bird flu problem.” The calculation section 210 calculates a frequency at which the word “bird” appears in the corpus DB 25 in each time period, thus obtaining the time series data shown in FIG. 3. In the time series data, the appearing frequency of the word “bird” increases from January to February and decreases from March through April.

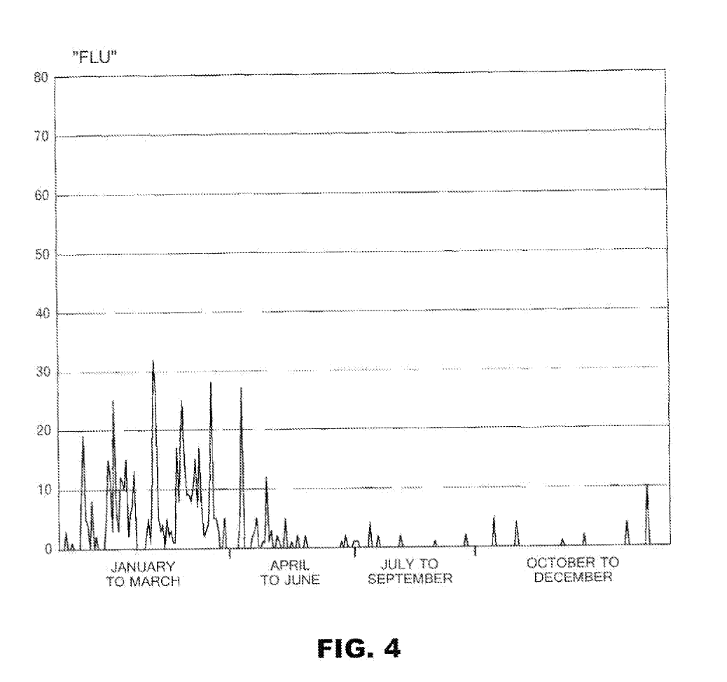

FIG. 4 is time series data showing sample appearing frequencies of the word “flu,” which is included in the compound candidate “bird flu problem.” The calculation section 210 calculates a frequency at which the word “flu” appears in the corpus DB 25 in each time period, thus obtaining the time series data shown in FIG. 4. In the time series data, the appearing frequency of the word “flu” increases from January to February and decreases from March through April.

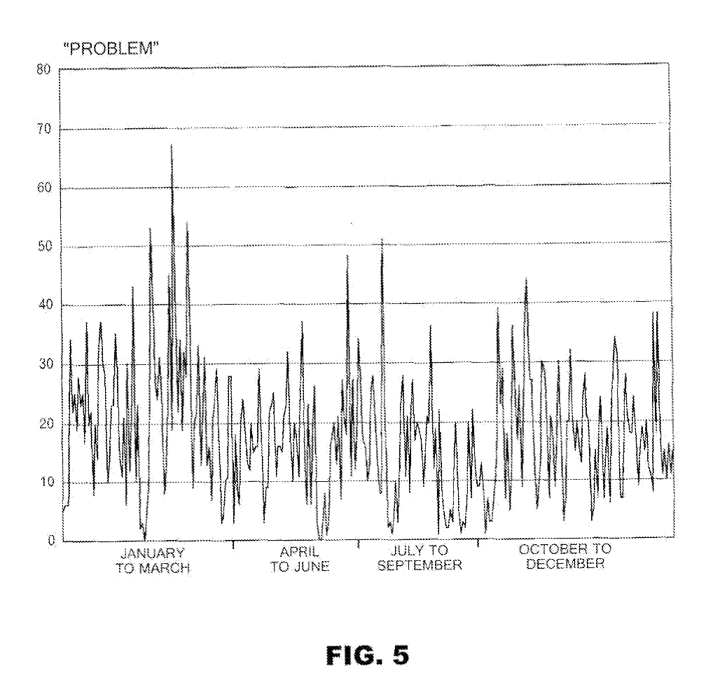

FIG. 5 is time series data showing sample appearing frequencies of the word “problem,” which is included in the compound candidate “bird flu problem.” The calculation section 210 calculates a frequency at which the word “problem” appears in the corpus DB 25 in each time period, thus obtaining the time series data shown in FIG. 5. In the time series data, the appearing frequency of the word “problem” peaks around February, while staying at various levels throughout the year.

Here, the description will refer to FIG. 2 again. Subsequently, the selection section 220 calculates a score, which represents a level used to determine whether or not the compound candidate should be extracted as a compound. The score is based on whether or not changes in the appearing frequencies of each word included in the compound candidate synchronize with one another in the time series data for each word (step S230). For example, a method for calculating a score is as follows. Here, assume that wₐₗₗ denotes a compound candidate and the compound candidate consists of m words. Then w₁ to wₘ denotes the respective words of the compound candidate and wₐₗₗ=w₁, . . . , wₘ.

First, the selection section 220 defines a difference between variations of appearing frequencies of a word with respect to time and variations of appearing frequencies of a different word with respect to time. Assume f(w, t) denotes an appearing frequency of a word w during a time period ΔT from a time point t. In addition, assume Δf(wᵢ, tₖ) denotes a difference between appearing frequencies of a word wᵢ at a time point tₖ and a time point tₖ₊₁. Accordingly, the following equation is obtained.

Equation 1

Δf(w₁, tₖ)=f(wᵢ, tₖ₊₁)−f(wᵢ, tₖ) Equation (1)

Assume Dₜ(wᵢ, wⱼ, tₖ)denotes a difference between successive appearing frequencies of word wᵢ and a difference between successive appearing frequencies of word wⱼ at a time point tₖ, and is defined as the following Equation (2) shows.

$$\begin{matrix}\text{Equation 2} & \\ {D}_{t} ( {w}_{i} , {w}_{j} , {t}_{k} ) {=}^{def} \frac{1}{Δ T} \vert Δ f ( {w}_{i} , {t}_{k} ) - Δ f ( {w}_{j} , {t}_{k} ) \vert & Equation ( 2 )\end{matrix}$$

The differences in all respective target time periods (t₀ to tₙ₋₁) for score calculation are added altogether. Accordingly, a difference level D_{T}(wᵢ, wⱼ) between changes of the respective frequencies of the corresponding words wᵢ and wⱼ is defined as the following Equation (3) shows.

$$\begin{matrix}\text{Equation 3} & \\ {D}_{T} ( {w}_{i} , {w}_{j} ) {=}^{def} {\sum }_{k = 0}^{n - 1} {D}_{t} ( {w}_{i} , {w}_{j} , {t}_{k} ) & Equation ( 3 )\end{matrix}$$

Using the difference level D_{T}(wᵢ and wⱼ) between the appearing frequencies of two words, the selection section 220 can obtain Dₐₗₗ, which denotes a difference level between the appearing frequencies of an important word and the appearing frequencies of each different word in the compound candidate wₐₗₗ. m-1 denoting the number of words (exclusive of the important word) is used for normalization. Dₐₗₗ is calculated on the basis of the following Equation (4).

$$\begin{matrix}\text{Equation 4} & \\ {D}_{all} = \frac{{\sum }_{i = 1 , i \neq core}^{m} {D}_{T} ( {w}_{i} , {w}_{core} )}{m - 1} & Equation ( 4 )\end{matrix}$$

According to the above-described Equation (4), the selection section 220 calculates a score indicating a level used to judge whether or not the compound candidate should be extracted as a compound. In this example, a lower score indicates that the variations of the appearing frequencies of the important word synchronize with the variations of the appearing frequencies of each different word.

Thereafter, on the basis of the score of the compound candidate, the selection section 220 judges whether or not the variations in the appearing frequencies of the important word synchronize with that of each different word (step S240). A different compound candidate may be used for the judgment. For instance, after obtaining scores for the plurality of compound candidates, the selection section 220 selects a certain number of compound candidates in ascending order of score. Each of the selected compound candidates may be judged as having variations synchronizing with that of each of the different words thereof. On the condition that the change in the appearing frequency of the important word synchronizes with that of each different word (step S240: YES), the selection section 220 selects the compound candidate as a compound (step S250).

In the example shown in FIGS. 3 to 5, while the changes in the appearing frequencies of the word “bird” synchronizes with that of the important word “flu,” the changes in the appearing frequencies of the word “problem” cannot be judged to be in synchronization with that of “flu.” Hence, “bird flu” is selected as a compound rather than “bird flu problem.”

Instead of the above-described processing, the selection section 220 may judge whether or not appearing frequencies of respective words synchronize with each other by generating time series data on the basis of how appearing frequencies of respective words change in each season or in each time span. For instance, the selection section 220 divides the obtained time series data into a plurality of pieces of data on a certain time period (for instance, one year, one month or one day). Thereafter, on the basis of the divided pieces of time series data, the selection section 220 obtains changes in the respective appearing frequencies of the corresponding words in the predetermined time period. The selection section 220 then selects whether to extract the compound candidate as a compound on the basis of whether or not the changes of the respective frequencies of the corresponding words synchronize with one another in the predetermined period. This method makes it possible to accurately extract a compound such as one specifically frequently used in a certain season and a time span.

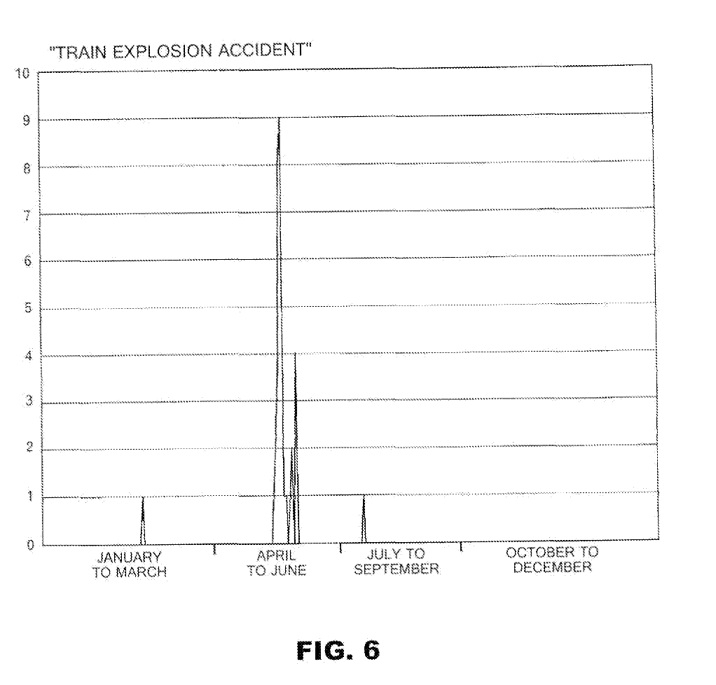

On the other hand, when the compound candidate does not include an important word (step S210: No), the calculation section 210 searches the second texts for the compound candidate and words included in the compound candidate. Thereafter, the calculation section 210 calculates variations in appearing frequencies of the compound candidate over time in the second texts and variations in appearing frequencies of each word included in the compound candidate over time in the second texts (step S260). For instance, when one of the compound candidates is “train explosion accident,” the calculation section 210 calculates the variations in appearing frequencies for the compound candidate “train explosion accident” over time and calculates variations in appearing frequencies for each of the words “train,” “explosion,” and “accident,” which are included in the compound candidate “train explosion accident,” over time. FIGS. 6 to 8 illustrate sample appearing frequencies of the compound candidate “train explosion accident” and the words “train,” “explosion,” and “accident” in the plurality of second texts in corpus DB 25 as time series data.

FIG. 6 is time series data showing sample appearing frequencies of the compound candidate “train explosion accident.” The calculation section 210 calculates a frequency at which the compound candidate “train explosion accident” appears in the corpus DB 25 in each time period, thus obtaining the time series data shown in FIG. 6. In the time series data, the appearing frequency of the compound candidate “train explosion accident” significantly increases from April to May, and is approximately zero in the other periods.

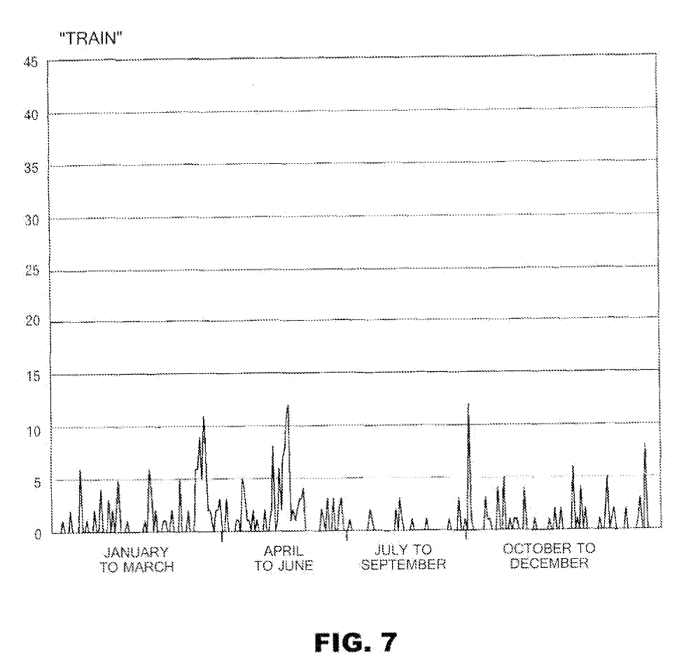

FIG. 7 is time series data showing sample appearing frequencies of the word “train,” which is included in the compound candidate “train explosion accident.” The calculation section 210 calculates a frequency at which the word “train” appears in the corpus DB 25 in each time period, thus obtaining the time series data shown in FIG. 7. In the time series data, although the appearing frequency of the word “train” significantly increases from April to May, it increases during specific periods in March and October as well. In addition, the frequency stably varies in the other periods.

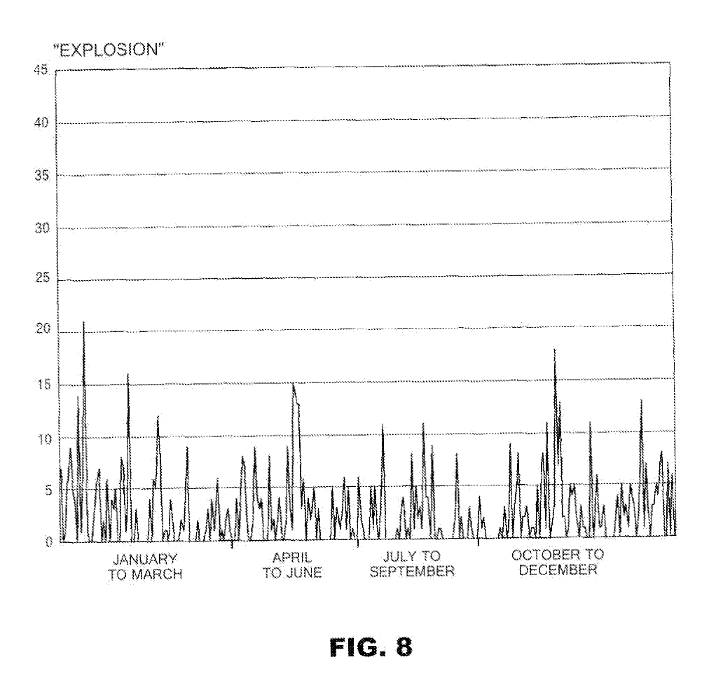

FIG. 8 is time series data showing sample appearing frequencies of the word “explosion,” which is included in the compound candidate “train explosion accident.” The calculation section 210 calculates a frequency at which the word “explosion” appears in the corpus DB 25 in each time period, thus obtaining the time series data shown in FIG. 8. In the time series data, the appearing frequency of the word “explosion” increases in January and November. In addition, the word “explosion” appears relatively frequently in the other periods as well.

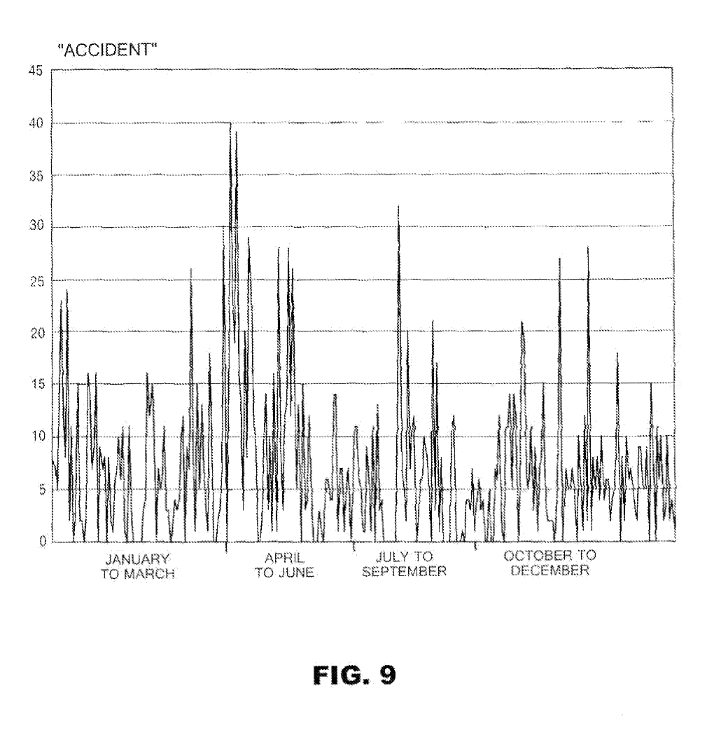

FIG. 9 is time series data showing sample appearing frequencies of the word “accident,” which is included in the compound candidate “train explosion problem.” The calculation section 210 calculates a frequency at which the word “accident” appears in the corpus DB 25 in each time period, thus obtaining the time series data shown in FIG. 9. In the time series data, the appearing frequency of the word “accident” significantly increases in March. Additionally, the appearing frequency of the word “accident” increases during specific periods in January, July, and November. The word “accident” appears relatively frequently in the other periods as well.

Here, the description will again refer to FIG. 2. At step S270, the selection section 220 calculates a score that is used to judge whether the compound candidate should be extracted as a compound. The score is calculated on the basis of whether or not changes in the appearing frequencies of the compound candidate in the time series data showing the appearing frequencies of the compound candidate over time synchronizes with changes in the appearing frequencies of each word included in the compound candidate in the time series data showing the appearing frequencies of the corresponding word over time (step S270).

The method described in step S230 can be applied to a method for calculating the score. For instance, the selection section 220 may use Equation (4) to calculate a score showing synchronicity between the compound candidate and each word constituting the compound candidate, instead of calculating a score representing synchronicity between the important word and the different word.

Thereafter, on the basis of the score of the compound candidate, the selection section 220 judges whether or not the change in the appearing frequencies of compound candidate synchronizes with the changes in the appearing frequencies of each word that constitutes the compound candidate (step S280). On the condition that the changes do not synchronize with each other (step S280: No), the selection section 220 selects the compound candidate as a compound (step S290).

In the examples shown in FIGS. 7 to 9, the variations in the appearing frequencies of the compound candidate “train explosion accident” do not synchronize with any of the variations of the appearing frequencies corresponding to the words “train,” “explosion,” and “accident.” For this reason, the compound candidate of “train explosion accident” is extracted as a compound. The output section 230 outputs the selected compound to the text retrieval device 30.

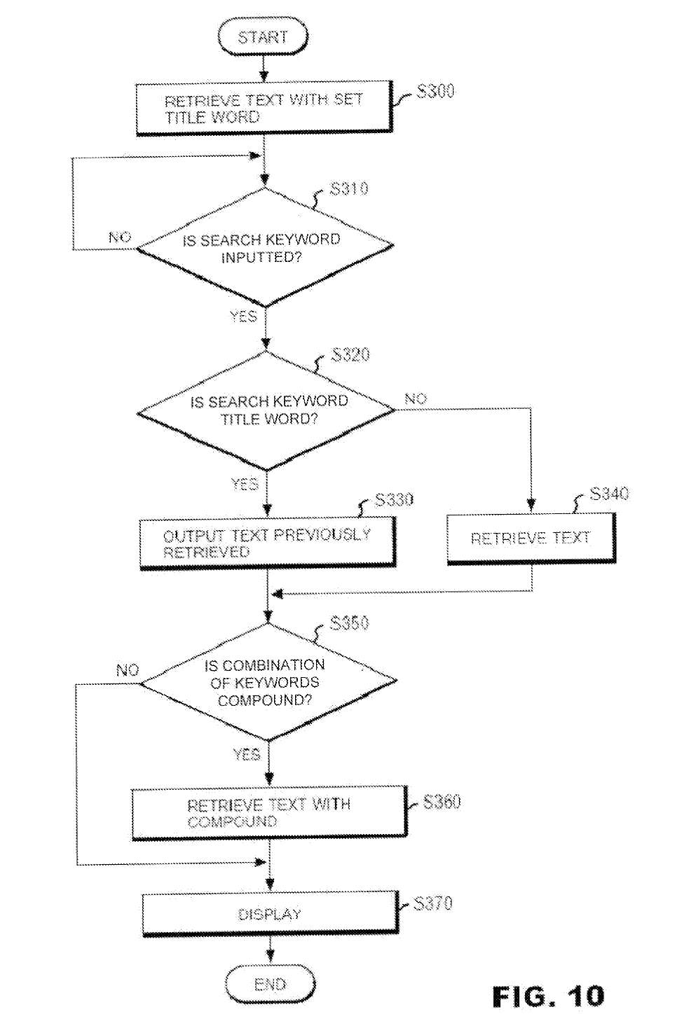

FIG. 10 is a flowchart of processing steps performed by the text retrieval device 30 to retrieve third texts according to an embodiment of the present invention. In the text retrieval device 30, words of the compound, which the text retrieval device 30 is notified of by the compound extraction device 20, are set as title words, in addition to any words previously set. First, the search section 320 retrieves third texts that include the title words from the communication network 35, and then stores the third texts in the storing section 300 (step S300). Subsequently, the input section 310 judges whether or not an input of a search keyword from a user has been received (step S310).

Once a search keyword is inputted (step S310: YES), the search section 320 judges whether or not the search keyword is one of the title words (step S320). When the search keyword is not one of the title words (Step S320: NO), the search section 320 retrieves third texts that include the search keyword from the communication network 35, and then outputs the third texts (step S340). When the search keyword is one of the title words (step S320: YES), the search section 320 reads the third texts from the storing section 300 that are associated with the search keyword, and then outputs the third texts (step S330).

The input section 310 may receive an input of a plurality of search keywords. In this case, once the plurality of search keywords are inputted, the search section 320, for instance, retrieves third texts that include the search keywords from the communication network 35, depending on user settings. In addition to this processing, the search section 320 may perform the following processing. In the processing, the search section 320 determines whether or not a combination of the search keywords constitute a compound that has been selected by the selection section 220 (step S350). For example, when search keywords “bird” and “flu” are inputted, the search keywords can be combined into a compound “bird flu.” Hence, the condition is satisfied if the compound “bird flu” has been selected by the selection section 220.

When the selection section 220 has selected a compound that includes the plurality of search keywords inputted into the input section 310 (step S350: YES), the search section 320 retrieves third texts that include the compound, in addition to the third texts that include the search keywords, from the communication network 35 (step S360). Thereafter, the search section 320 outputs the results of the retrieval in a way that, for instance, the result is displayed on a screen (step S370).

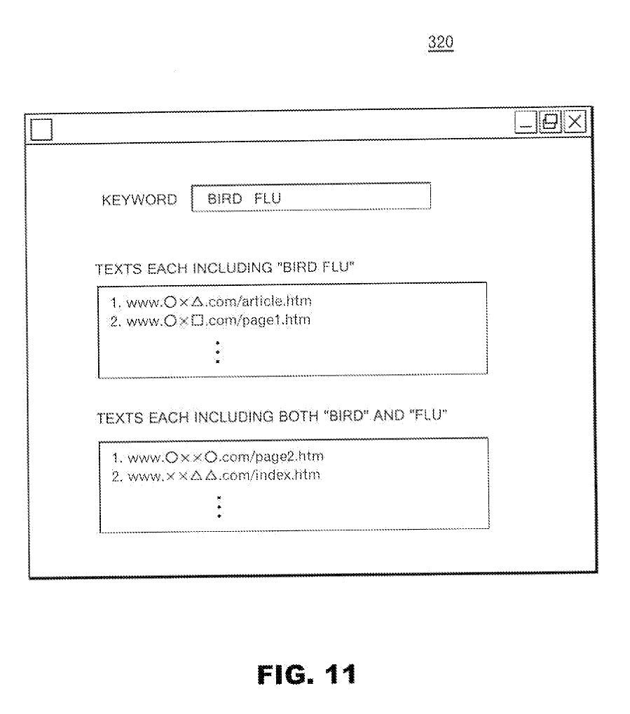

FIG. 11 shows an example of a display of the retrieval result outputted by the search section 320 of the embodiment of the present invention. In this display example, a search keyword input field is displayed on an upper portion of the screen. In the search keyword input field, the words “bird” and “flu” are displayed. In response to an input of the search keywords, the search section 320 retrieves third texts that include a compound consisting of a combination of the search keywords and third texts that include the search keywords. Retrieval result(s) are then displayed on the screen.

In the example of FIG. 11, the Uniform Resource Locators (URLs) of web pages that include the compound “bird flu” are displayed. In addition, the URLs of web pages that include the words “bird” and “flu” are displayed as well. As in the example of FIG. 11, the search section 320 may display texts that include the compound in priority to the texts that include the search keywords but not the compound (for instance, in an upper output field). Accordingly, texts highly relevant to the search keywords as a compound can be displayed in priority to the texts that merely include the search keywords. Thereby, usability for users can be enhanced.

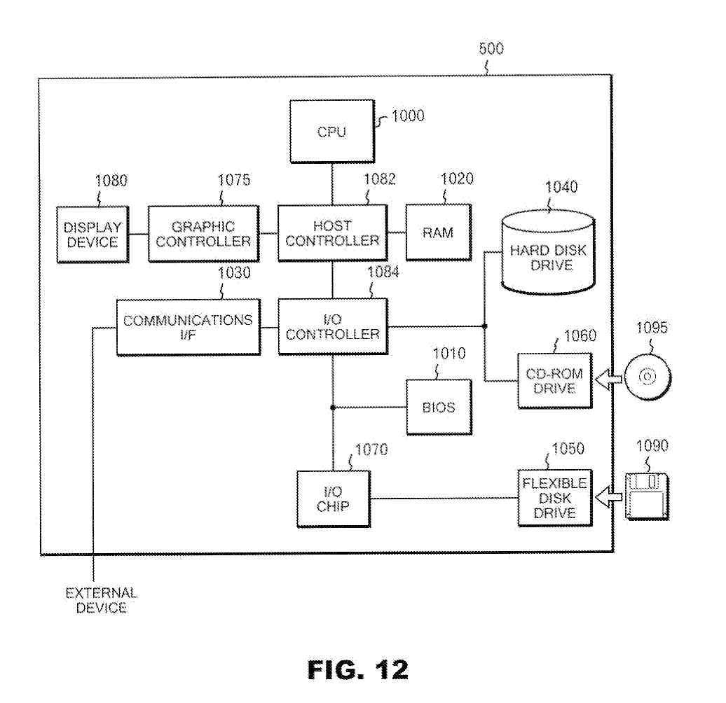

FIG. 12 shows an example of a hardware configuration of an information processing device 500 according to an embodiment of the present invention. The information processing device 500 can function as the compound extraction device 20 or the text retrieval device 30. The information processing device 500 includes a CPU peripheral section, an I/O section, and a legacy I/O section. The CPU peripheral section includes: a CPU 1000, a RAM 1020, and a graphic controller 1075, all of which are connected one to another by a host controller 1082. The I/O section includes: a communications interface 1030, a hard disk drive 1040, and a CD-ROM drive 1060, each of which is connected to the host controller 1082 via an I/O controller 1084. The legacy I/O section includes: a BIOS 1010, a flexible disk drive 1050, and the I/O chip 1070, each of which is connected to the I/O controller 1084.

The host controller 1082 connects the RAM 1020 to the CPU 1000 and the graphic controller 1075, which can access the RAM 1020 at a high transmission rate. The CPU 1000 controls each of the sections on the basis of programs stored in the BIOS 1010 and the RAM 1020. The graphic controller 1075 obtains image data, which are generated in a frame buffer provided in the RAM 1020 by the CPU 1000 or the like. The graphic controller 1075 then displays the image data on a display device 1080. Alternatively, the graphic controller 1075 may include a frame buffer therein for storing image data generated by the CPU 1000 or the like.

The I/O controller 1084 connects the host controller 1082 to each of the communications interface 1030, the hard disk drive 1040, and the CD-ROM drive 1060, which are I/O devices transmitting data at relatively higher rates. The communications interface 1030 communicates with external devices via a network. The hard disk drive 1040 stores program(s) and data, which the information processing device 500 uses. The CD-ROM drive 1060 reads program(s) or data from a CD-ROM 1095, and then provides the program(s) or data to the RAM 1020 or the hard disk drive 1040.

In addition, the BIOS 1010 and I/O devices such as the flexible disk drive 1050 and the I/O chip 1070, which I/O devices transmits data at a relatively lower rate, are connected to the I/O controller 1084. The BIOS 1010 stores a boot program, which is executed by the CPU 1000 when the information processing device 500 is booted, and a program depending on the hardware of the information processing device 500, and the like. The flexible disk drive 1050 reads program(s) or data from a flexible disk 1090, and then provides the program(s) or data to the RAM 1020 or the hard disk drive 1040. The flexible disk 1090 and various I/O devices are connected to the I/O chip 1070 via a parallel port, a serial port, a keyboard port, a mouse port, and the like.

A program, which is provided to the information processing device 500 by a user, is stored in a recording medium such as the flexible disk 1090, the CD-ROM 1095, or an integrated circuit (IC) card. The program is read from the recording medium via the I/O chip 1070 and/or the I/O controller 1084. Thereafter, the program is installed in the information processing device 500 and executed. The program causes the information processing device 500 to perform the same operations as those of the compound extraction device 20 or those of the text retrieval device 30 described above with respect to FIGS. 1 to 11. For this reason, descriptions will be omitted of the operations of the information processing device 500. Note that the program for causing the information processing device 500 as the text retrieval device 30 is, for instance, search software called “search engine.” Meanwhile, the program for causing the information processing device 500 to function as the compound extraction device 20 is an add-on program for adding an additional function to such search software. In this case, the single information processing device 500 is caused to function as both of the text retrieval device 30 and the compound extraction device 20. It goes without saying that such modes are included in scope of claims of the present invention.

The programs described above may be stored in an external recording medium. In addition to the flexible disk 1090 and the CD-ROM 1095, the record medium may also be an optical recording medium, such as a digital video disc (DVD), a magneto optical recording medium, such as a mini-disc (MD), a tape medium, a semiconductor memory, such as an IC card, or the like. In addition, a storing device such as a hard disk or a RAM, which is provided to a server system connected to a dedicated communication network or the Internet, may be used as a recording medium. By using such a recording device, a program can be provided to the information processing device 500 via the network.

As described, the compound extraction device 20 can enhance the accuracy of the extraction of a compound because the compound is extracted on the basis of changes in the appearing frequencies of words over time rather than simply the appearing frequencies of words. In order to extract a compound, dates at which respective texts in a corpus is written are necessary. In bulletin boards on the Internet, which has been developing in recent years, and the like, such information can be collected with ease, and the information is highly compatible with existing techniques. In addition, the text retrieval device 30 of the embodiment uses a compound, which is detected highly accurately, as title words for text retrieval. This can make the text retrieval process more efficient and can increase accuracy of the text retrieval.

As described, the present invention has been described by use of embodiments of the present invention. However, the technical scope of the invention is not limited to the above-described embodiments. It goes without saying that those skilled in the art can make various modifications, alternations and improvement to the above embodiments. From the descriptions in the scope of claim, it goes without saying that embodiments, to which such alternation or improvement is made, may be included in the technical scope of the invention.

What is claimed is:

1. A system for extracting a compound from a plurality of texts, the system comprising:
an obtaining section that analyzes a plurality of first texts and obtains a compound candidate based on analysis of the plurality of first texts;
a calculation section that searches a plurality of second texts for each word included in the compound candidate and calculates appearing frequencies of each word included in the compound candidate in the plurality of second texts; and
a selection section that selects whether to extract the compound candidate as a compound on the basis of whether or not changes in the appearing frequencies of each word included in the compound candidate synchronize with one another when the appearing frequencies of each word included in the compound candidate are arranged as time series data in which the appearing frequencies of each word included in the compound candidate are in chronological order based on publication dates of the plurality of second texts.

2. The system of claim 1,
wherein the obtaining section further obtains a plurality of compound candidates based on analysis of the plurality of first texts,
wherein, for each of the plurality of compound candidates,
the calculation section further searches the plurality of second texts for each word included in the corresponding compound candidate and calculates appearing frequencies of each word included in the corresponding compound candidate in the plurality of second texts, and
the selection section further calculates a score based on whether or not changes in the appearing frequencies of each word included in the corresponding compound candidate synchronize with one another when the appearing frequencies of each word included in the corresponding compound candidate are arranged as time series data in which the appearing frequencies of each word included in the corresponding compound candidate is in chronological order based on publication dates of the plurality of second texts, and
wherein the selection section further selects to extract one of the plurality of compound candidates as a compound based on the score of the one compound candidate.

3. The system of claim 1, wherein, responsive to the compound candidate including a previously specified word, the selection section selects to extract the compound candidate as a compound on the condition that changes in the appearing frequencies of the previously specified word synchronize with changes in the appearing frequencies of a different word included in the compound candidate.

4. The system of claim 1, wherein, responsive to the compound candidate including a medium frequency word that has appearing frequencies under a predetermined upper limit and above a predetermined lower limit, the selection section selects to extract the compound candidate as a compound on the condition that changes in the appearing frequencies of the medium frequency word synchronize with changes in the appearing frequencies of a different word included in the compound candidate.

5. The system of claim 4, wherein the different word is a modifier on the medium frequency word.

6. The system of claim 1, wherein responsive to the compound candidate not including a previously specified word,
the calculation section searches the plurality of second texts for the compound candidate and calculates appearing frequencies of the compound candidate in the plurality of second texts, and
the selection section selects whether to extract the compound candidate as a compound on the basis of whether or not changes in the appearing frequencies of the compound candidate synchronize with changes in the appearing frequencies of each word included in the compound candidate when the appearing frequencies of the compound candidate and the appearing frequencies of each word included in the compound candidate are arranged as time series data in which the appearing frequencies are in chronological order based on publication dates of the plurality of second texts.

7. The system of claim 1, wherein
the selection section divides the time series data corresponding to each word included in the compound candidate into a plurality of data pieces, each data piece corresponding to a certain time period,
the selection section determines changes in the appearing frequencies of each word in the certain time period using the data piece corresponding to the certain time period for the word, and
the selection section selects whether to extract the compound candidate as a compound on the basis of whether or not the changes in the appearing frequencies of each word in the certain time period synchronize with one another.

8. The system of claim 1, further comprising:
a storing section that stores a third text that includes a plurality of title words previously set;
an input section that receives an input of a keyword; and
a search section that reads the third text from the storing section responsive to the keyword being one of the plurality of title words,
wherein the plurality of title words are previously set by the selection section as the words of the compound selected by the selection section.

9. The system of claim 8, further comprising:
an output section that outputs to the storing section the compound selected by the selection section.

10. The system of claim 1, further comprising:
an input section that receives an input of a plurality of keywords; and
a search section that searches a plurality of target third texts and retrieves a third text that includes the plurality of keywords,
wherein, responsive to the compound selected by the selection section including the plurality of keywords, the search section further searches the plurality of target third texts and retrieves another third text that includes the compound.

11. The system of claim 10, wherein the search section further outputs the third text that includes the plurality of keywords and the other third text that includes the compound.

12. The system of claim 1, further comprising:
an output section that outputs the compound selected by the selection section to a text retrieval device, the text retrieval device comprising:
an input section that receives an input of a plurality of keywords, the plurality of keywords being included in the compound selected by the selection section; and
a search section that searches a plurality of target third texts and retrieves a third text that includes each of the plurality of keywords and another third text that includes the compound selected by the selection section.

13. The system of claim 1, wherein the obtaining section analyzes the syntax of each of the plurality of first texts to determine the word class of each word in the respective first text and obtains a plurality of successively appearing nouns as the compound candidate.

14. A system for extracting a compound from a plurality of texts, the system comprising:
an obtaining section that analyzes a plurality of first texts and obtains a compound candidate based on analysis of the plurality of first texts;
a calculation section that searches a plurality of second texts for the compound candidate and each word included in the compound candidate and calculates appearing frequencies of the compound candidate and each word included in the compound candidate in the plurality of second texts; and
a selection section that selects whether to extract the compound candidate as a compound on the basis of whether or not changes in the appearing frequencies of the compound candidate synchronize with changes in the appearing frequencies of each word included in the compound candidate when the appearing frequencies of the compound candidate and the appearing frequencies of each word included in the compound candidate are arranged as time series data in which the appearing frequencies are in chronological order based on publication dates of the plurality of second texts.

15. The system of claim 14,
wherein the obtaining section further obtains a plurality of compound candidates based on analysis of the plurality of first texts,
wherein, for each of the plurality of compound candidates,
the calculation section further searches the plurality of second texts for the corresponding compound candidate and each word included in the corresponding compound candidate and calculates appearing frequencies of the corresponding compound candidate and each word included in the corresponding compound candidate in the plurality of second texts, and
the selection section further calculates a score based on whether or not changes in the appearing frequencies of the corresponding compound candidate synchronize with changes in the appearing frequencies of each word included in the corresponding compound candidate when the appearing frequencies of the corresponding compound candidate and the appearing frequencies of each word included in the corresponding compound candidate are arranged as time series data in which the appearing frequencies are in chronological order based on publication dates of the plurality of second texts, and
wherein the selection section further selects to extract one of the plurality of compound candidates as a compound based on the score of the one compound candidate.

16. The system of claim 14, wherein the compound candidate does not include a previously specified word.

17. The system according to claim 14, wherein the compound candidate does not include a medium frequency word that has appearing frequencies under a predetermined upper limit and above a predetermined lower limit.

18. A method for extracting a compound from a plurality of texts, the method comprising:
analyzing a plurality of first texts;
obtaining a compound candidate based on analysis of the plurality of first texts;
searching a plurality of second texts for each word included in the compound candidate;
calculating appearing frequencies of each word included in the compound candidate in the plurality of second texts; and
selecting whether to extract the compound candidate as a compound on the basis of whether or not changes in the appearing frequencies of each word included in the compound candidate synchronize with one another when the appearing frequencies of each word included in the compound candidate are arranged as time series data in which the appearing frequencies of each word included in the compound candidate are in chronological order based on publication dates of the plurality of second texts.

19. A computer program that causes an information processing device to function as a system for extracting a compound from a plurality of texts, the computer program causing the information processing device to function as:
an obtaining section that analyzes a plurality of first texts and obtains a compound candidate based on analysis of the plurality of first texts;
a calculation section that searches a plurality of second texts for each word included in the compound candidate and calculates appearing frequencies of each word included in the compound candidate in the plurality of second texts; and
a selection section that selects whether to extract the compound candidate as a compound on the basis of whether or not changes in the appearing frequencies of each word included in the compound candidate synchronize with one another when the appearing frequencies of each word included in the compound candidate are arranged as time series data in which the appearing frequencies of each word included in the compound candidate are in chronological order based on publication dates of the plurality of second texts.

20. A computer program product comprising a computer readable medium, the computer readable medium including a computer readable program for extracting a compound from a plurality of texts, wherein the computer readable program when executed on a computer causes the computer to:
analyze a plurality of first texts;
obtain a compound candidate based on analysis of the plurality of first texts;
search a plurality of second texts for each word included in the compound candidate;
calculate appearing frequencies of each word included in the compound candidate in the plurality of second texts; and
select whether to extract the compound candidate as a compound on the basis of whether or not changes in the appearing frequencies of each word included in the compound candidate synchronize with one another when the appearing frequencies of each word included in the compound candidate are arranged as time series data in which the appearing frequencies of each word included in the compound candidate are in chronological order based on publication dates of the plurality of second texts.
